(19) United States
(12) Patent Application Publication
(10) Pub. No.: US 2004/0044617 A1
(43) Pub. Date: Mar. 4, 2004

(54) Methods and systems for enterprise risk auditing and management

(76) Inventor: Duojia Lu, Plymouth Meeting, PA (US)

Correspondence Address: Jian Ma, 137 Rinconada Avenue, Palo Alto, CA, 94301, US

(21) Appl. No.: 10/640,213

(22) Filed: Aug. 12, 2003

Related U.S. Application Data
(60) Provisional application No. 60/407,791, filed on Sep. 3, 2002.

(51) Int. Cl. G06F 17/60

(52) U.S. Cl. 705/38

(57) ABSTRACT

Embodiments of this invention relate to methods and systems for auditing, evaluating, and making an integrated assessment of risks associated with an enterprise, which may be measured relative to a set of industrial benchmarks. Embodiments of the invention can be used, for example, as a diagnostic tool that enables an enterprise to have a comprehensive view of various types of risks it is facing and their potential impact, as well as to test out effective ways to mitigate and manage the risks. Embodiments of the invention can also be integrated as part of an enterprise's asset management infrastructure. In addition, Embodiments of the invention can be used as a “risk auditor,” e.g., conducted regularly or on demand in a manner similar to how financial auditing is performed.

### CROSS REFERENCE TO RELATED APPLICATIONS

This application claims priority to U.S. Provisional Patent Application No. 60/407,791, filed Aug. 14, 2002, the entirety of which is hereby incorporated by reference.

### FIELD OF THE INVENTION

This invention generally relates to risk management. In particular, it relates to a novel system and method for auditing and assessing risks associated with an enterprise, or a multi-level organization.

### BACKGROUND

Risk is inherent in every business. Risk management has become an integral part of modem business operation, and plays a crucial role in an enterprise's asset management. Such stems from that every enterprise is established and operates for a purpose in the future; and risk is intimately associated with various uncertainties along the process. To navigate in an increasingly volatile business environment, it is imperative for an enterprise to regularly audit and actively manage its collective risks, as well as those related to its business partners (e.g., suppliers, clients, banks, insurance companies, etc.). In addition, various government regulatory agencies, shareholders, and financial institutions also demand to know how an enterprise deals with its risks.

Conventional risk management tools typically deal with a particular type of risks (e.g., credit risks), or risks associated with a single business process such as a software project. A business enterprise, by contrast, is a complex “eco-system,” in that it not only has multiple divisions/departments in a multi-level hierarchical structure, but also interacts with a number of external “sources” (such as its business partners and regulatory agencies) in a dynamic manner. Hence, associated with such system are multiple risk categories that are inter-related, and dynamic in nature.

In view of the forgoing, a need exists in the art for a method and system that can effectively perform risk auditing and management for an enterprise.

### SUMMARY

Embodiments of this invention relate to methods and systems for auditing, evaluating, and making an integrated assessment of risks associated with an enterprise, e.g., based on various industrial benchmarks, and/or relative to a set of predetermined risk measurement units.

In one embodiment, a method for enterprise risk management comprises: determining a context associated with an enterprise; categorizing risks associated with the enterprise into a plurality of risk categories, each risk category including at least one risk; determining a risk structure that correlates the risk categories; and evaluating the risks associated with the enterprise. The method may further include providing an integrated assessment of the risks associated with the enterprise, based at least in part on the evaluation.

Embodiments of the invention can be used, for example, as a diagnostic tool that enables an enterprise to have a comprehensive view of various types of risks it is facing and their potential impact, as well as to test out effective ways to mitigate and manage the risks. Embodiments of the invention can also be integrated as part of an enterprise's asset management infrastructure. In addition, Embodiments of the invention can be used as a “risk auditor,” e.g., conducted regularly or on demand in a manner similar to how financial auditing is performed.

Further details and advantages of embodiments of the invention are set forth below.

### BRIEF DESCRIPTION OF THE FIGURES

FIG. 1 depicts a flowchart illustrating one embodiment of the invention;

FIG. 2 illustrates how context, event and time are related in a scenario space, according to an embodiment of the invention;

FIG. 3 depicts an embodiment of a risk structure associated with an enterprise, according to the invention; and

FIG. 4 shows how a risk probability distribution function may be constructed, according to an embodiment of the invention.

### DETAILED DESCRIPTION

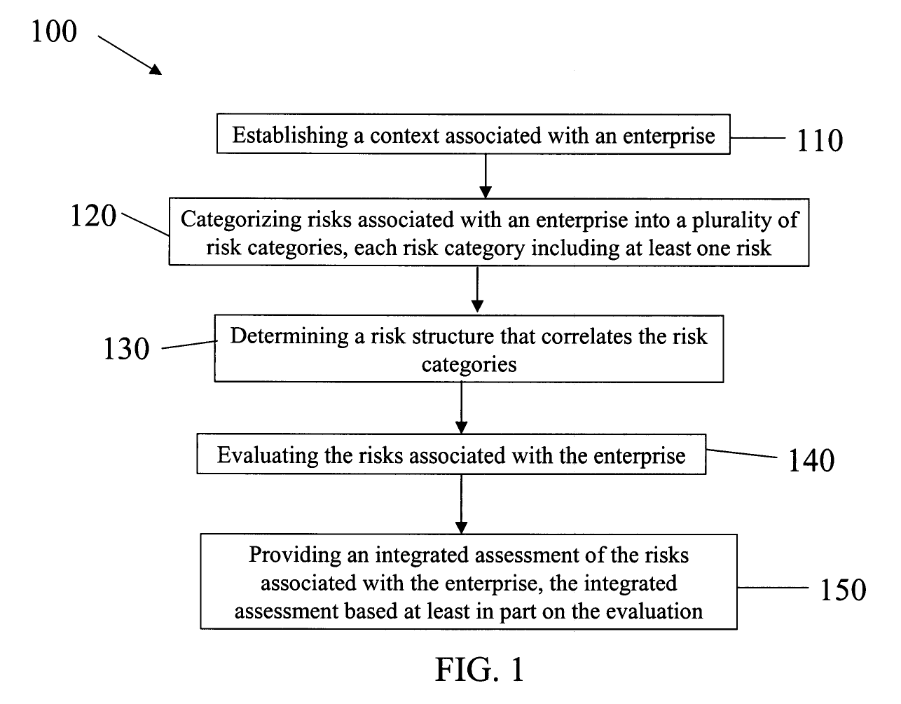

FIG. 1 depicts a flowchart illustrating an embodiment of a method of the invention. Flowchart 100 comprises: determining a context associated with an enterprise, as recited in step 110; categorizing risks associated with an enterprise into a plurality of risk categories, each risk category including at least one risk, as recited in step 120; determining a risk structure that correlates the risk categories, as recited in step 130; and evaluating the risks associated with the enterprise, as recited in step 140.

As used herein, the term “risk” is construed broadly to include a situation in which, at a future time and relative to a projection (or “goal”), there are several possible results that may influential. Simply put, a risk represents the chance of deviation from the goal. A risk is characteristically context (or situation) sensitive, and dynamic in nature. A risk may include (but is not limited to) the following components: a time horizon or period (or “time domain”); a set of potential events or actions (or “event domain”); a set of potential results or outcomes; a projection of the results or outcomes (or “plan”), including the current resource allocation and belief; the entity for which different potential results or outcomes are meaningful (or “ownership”); the value of the results or outcomes that include both the objective value and the subjective value (or “value”). A risk may be for example related to a loss caused by a trade credit default, an indirect loss due to a catastrophe occurred to a sole supplier, a gain/loss in the market share of a new product or service, a decline in demand due to adverse weather conditions, an employee injury (occupational and non-occupational), or a direct or indirect damage caused by a man-made disaster.

The term “enterprise” is construed broadly to include any organization or organized entity, such as a business organization, a financial institution, an educational institution, a political party, a union, or a foundation. In general, an enterprise can be considered as a group of people organized for a certain purpose. An enterprise may have sub-organizational structures such as multiple divisions/departments, for example, arranged in a multi-level hierarchical structure.

The term “context” is construed to include information (or data) about an enterprise's situation at any given time. A context may be viewed, for example, as a “snapshot” of the enterprise at a given time. The context of an enterprise may be for example categorized into a number of categories, including (but not limited to): financial information, operational information, strategic information, regulatory information, and market information. It may further include information (or data) related to the enterprise's internal structure, as well as its external environment. The context of an enterprise may serve as a background for setting up a “scenario,” as described below.

As used herein, the term “scenario” refers to a possible path an enterprise may take between the present and a future time (or between two future times). A scenario may comprise one or more “events,” taking place along the path at various times. An “event” herein refers to the occurrence of a situation that may affect the evaluation of one or more risks. In general, when an event occurs, the context changes. Two scenarios may be considered identical, if they comprise the same events taking place at the same times. Examples of an event may include (but are not limited to): the occurrence of a fire, a Fed interest rate change, a law suit brought by a competitor (or a third party), the discontinuity of a product, a new product introduced to the market by a competitor, a power outage, and so on.

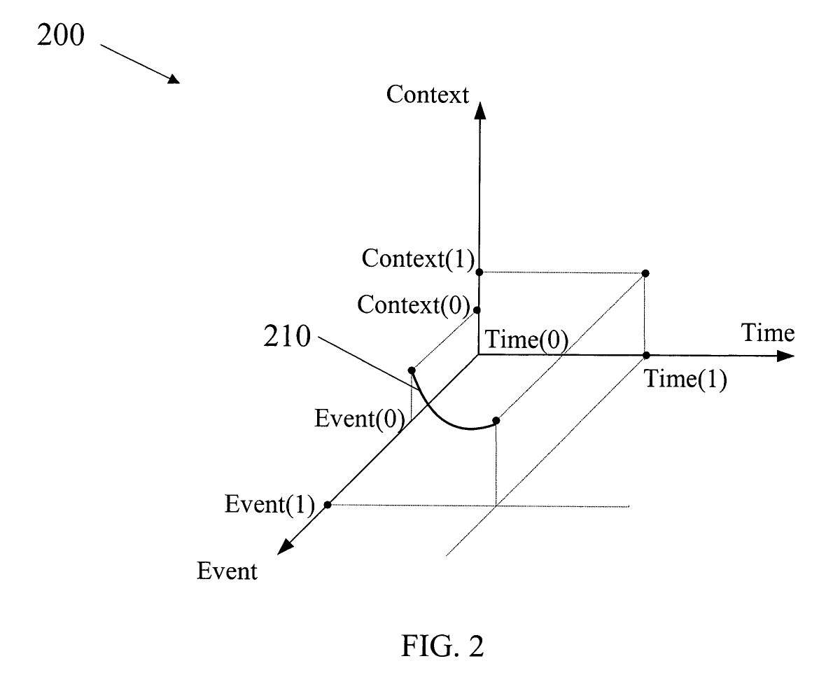

As a way of example, FIG. 2 illustrates how context, event, and time can be related in a “scenario space” 200, according to an embodiment of the invention. For example, curve 210 represents one scenario along which the context evolves from Context(0) at Time(0) to Context(1) at Time(1), by way of a plurality of intervening events including Event(0) and Event(1). As such, a scenario may provide a possible “roadmap” that leads the context from one time to another (e.g., from the present to the future), thereby rendering the context dynamic.

The context associated with an enterprise may be determined in a number of ways, as deemed appropriate for a given application. In one embodiment, an interactive questionnaire may be posed to a user (or “risk manager”), e.g., as a systematic and effective way to collect information/data in various categories. Other sources of information, such as historical or statistical data, executive intuition and judgment, etc., may also be utilized to derive additional context information. The content of the questionnaire may be further modified, based upon the risk manager's input. The questionnaire may also be used periodically to update the context information. The context information can also be updated at any time whenever the situation changes or an event occurs.

In the embodiment of FIG. 1, the risks associated with an enterprise may generally be categorized into a plurality of risk categories, including (but not limited to) financial, operational, strategic, and market risk categories. Each of these “top-level” categories may further comprise a plurality of sub-categories, such as regulatory, credit, liquidity, property, liability, intellectual property, and political risk categories. Under each sub-category, there may be additional subcategories, and so on.

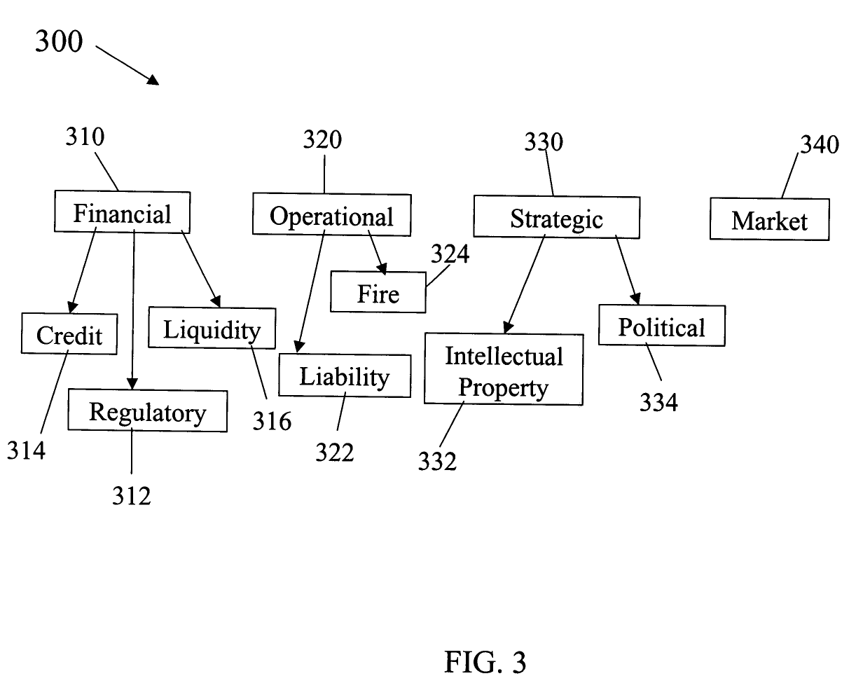

In one embodiment, a hierarchical (e.g., “tree-like”) structure can be used as the “risk structure” to characterize how various risk categories described above are inter-connected (or correlated). FIG. 3 depicts an embodiment of a risk structure, according to the invention. By way of example, risk structure 300 may comprise a plurality of “nodes” configured in a tree-like hierarchical structure, where each node corresponds to a particular risk category. For example, nodes 310, 320, 330, 340 may correspond to financial, operational, strategic, and market risk categories, respectively. Node 310 may further include a plurality of “sub-nodes” 312, 314, 316, e.g., relating to regulatory, credit, and liquidity risk categories, respectively. Node 330 may further include a plurality of “sub-nodes” 332, 334, e.g., relating to intellectual property and political risk categories, respectively. Node 320 may further include a plurality of “sub-nodes” 322, 324, e.g., relating to liability and fire risk categories, respectively. The risk structure 300 can also be dynamically modified, e.g., one or more nodes representing additional risk categories can be added to the risk structure 300 via appropriate linkages. As such, a risk structure according to the invention provides a systematic overview of all the identifiable risks associated with an enterprise, along with their lineage and correlation, thus making it possible to provide an integrated risk assessment for the entire enterprise, as the ensuing description further describes.

Referring back to FIG. 1. The evaluation of the risks categories (along with the constituent risks in each category) may be carried out in a manner that yields appropriate results for a given application. In some applications, for example, it may be desirable to evaluate the risks in a quantitative fashion, such that each obtains a “score,” e.g., measured relative to a predetermined risk measurement unit (e.g., a corresponding industry benchmark). In other applications, some risks may be evaluated in a qualitative manner, e.g., measured by a “high” or “low.”

In one embodiment of the invention, the risk measurement units associated with various risks can be determined by identifying at least one “reference case,” such as an industry leader and/or an industry laggard (or “failure”). A method of the invention such as the embodiment of FIG. 1 is then applied to the industry leader/laggard and the associated risks are evaluated (e.g., by devising a suitable evaluation procedure). The risk evaluations thus obtained (e.g., a set of “reference scores”) can be used as a set of “industry benchmarks” and thus serve as the “risk measurement units.” Subsequently, the risk evaluation procedure devised for the above reference case can be applied to an enterprise of interest, and a set of scores are obtained for various risk categories (and the constituent risks) accordingly, which are effectively measured relative to the respective risk measurement units. As such, use of such risk measurement units (e.g., industry benchmarks) provide a standardized comparison, which can be useful in identifying and mitigating those risks that are adverse to the enterprise's strategic plan and desired goals.

In one embodiment, a probability distribution function may be constructed for each risk. This may be accomplished by constructing all possible scenarios (along with the underlying events) associated with the risk and assigning a probability value to each scenario. Such process may involve for example making use of historical and statistical data, applying industry benchmarks, taking into account executive intuition and judgment, carrying out simulations, and so on.

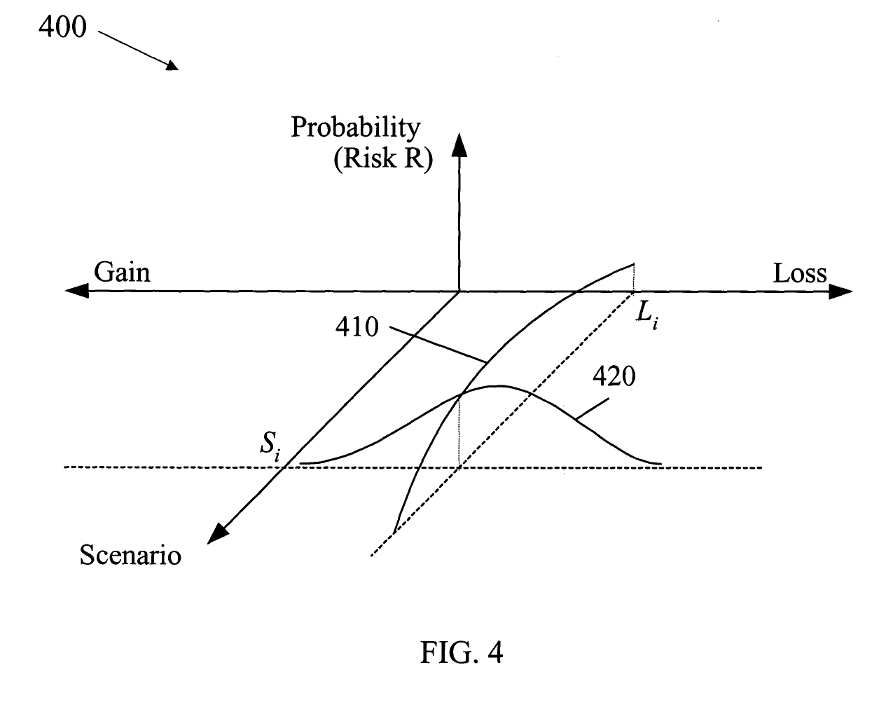

As a way of example, FIG. 4 illustrates a probability distribution function 410, in a “probability space” 400, where Probability (associated with a Risk R) is plotted as a function of Scenario, at a particular value Lᵢ of Gain/Loss. Also shown in FIG. 4 is a probability distribution function 420, where Probability (Risk R) is plotted as a function of Gain/Loss, at a particular scenario Sᵢ. An integration of the probability distribution function 420 along the Gain/Loss axis yields a probability value for the scenario Sᵢ (associated with the Risk R) over all gain/loss values. Whereas an integration of the probability distribution function 410 along the Scenario axis yields a probability value for Risk R at the gain/loss Lᵢ.

One or more parameters can be further defined for each risk, which may for example serve as some “constraints” to the risk under consideration. For instance, the parameters may be geographical, organizational, or time limits. They may also be related to revenue growth, profit growth, loss limit, cash flow, etc. The parameters can be further used to indicate how the risk is to be measured. For example, a criterion for a risk related to fire loss may be set at above $1000 level, such that a loss below $1000 will be retained by the enterprise, while a loss above $1000 will be transferred by an insurance program.

Furthermore, a parameter may be use to represent a “weight” associated with a “lower-level” risk such as a risk in a sub-category (e.g., corresponding to a sub-node 312, 314, or 316 in FIG. 3). The “weight” can be useful in determining how the lower-level risks are aggregated to their “parent” (on an upper level) category (such as the node 310 of FIG. 3), for the lower-level risks contribute to the upper-level risk metrics.

In addition, a “risk exposure” may be defined for each risk, e.g., to restrict the risk evaluation in a particular range. For example, a risk exposure may be used to cut off (or filter out) events/scenarios or risk probability values that are too insignificant (or small) to be practically meaningful. This can be useful in a complex evaluation process. In the embodiment of FIG. 4, for example, a risk exposure for Risk R may be set up such to cover the section of the probability distribution function 410 where Probability is greater than a certain value (e.g., 10%).

The embodiment of FIG. 1 can be used to carry out a “what-if” risk analysis, where various scenarios and assumptions are played out and the associated risks are evaluated, for instance. Such analysis enables various risks to be monitored and managed in a proactive manner, and can be beneficial for the enterprise strategic planning.

The flowchart 100 of FIG. 1 may further include providing an integrated assessment of the risks associated with the enterprise, based at least in part on the evaluation, as recited in step 150. For example, based on the results of the evaluation step 140 (e.g., a set of scores measured relative to a set of risk measurement units such as industry benchmarks), the enterprise's existing risk management strategy can be examined, and ineffective areas identified. Furthermore, a “what-if” analysis as described above may be carried out to help devise a more effective and coherent strategy. In addition, various plans/strategies related to risk retention, risk financing, risk avoidance, risk prevention, risk transfer, risk hedging, and other means of risk management can be tested out and devised accordingly.

The methods and systems of the invention can be used in a variety of applications, e.g., providing effective risk auditing and management for various organizations. In one embodiment, a database (or other computer program products) may be constructed, e.g., based on the embodiment of FIG. 1, where the related context information, the risk categories, the risk structure are stored. Various data associated with the risk evaluation process (e.g., scenarios along with events and risk probability distribution functions constructed, risk parameters and risk exposures defined, risk measurement units determined, etc.), along with the results of the evaluation (e.g., a set of scores) can also be stored. The database may be maintained/administered internally (e.g., by a risk manager), and/or externally (e.g., by an outside consulting agency). The database can be updated on a regularly basis, on demand, and/or when an event occurs (e.g., a Fed interest rate change). The risk evaluation and assessment are performed accordingly, as well. Such a database (or any other systems in accordance with the invention) can effectively serve as a “risk auditor,” e.g., allowing the risk management to be audited/assessed regularly or on demand, in a manner similar to how financial management is audited.

The database (or other computer program products) in the above can be stored in a memory or a computer-readable medium, in communication with a processor (e.g., embodied in a computer or a processing unit, or a network server). Embodiments of a computer-readable medium include, but are not limited to, an electronic, optical, magnetic, or other storage or transmission device capable of providing a processor with computer-readable (or machine-readable) instructions. Other examples of suitable media include, but are not limited to, a floppy disk, CD-ROM, magnetic disk, memory chip, ROM, RAM, an ASIC, a configured processor, all optical media, all magnetic tape or other magnetic media, or any other medium from which a processor can read instructions. Also, various other forms of computer-readable media may transmit or carry instructions to a computer, including a router, a private or public network, or other transmission device or channel wired and/or wireless. The instructions may comprise code from any computer-programming language, including, for example, C, C++, Visual Basic, Java, and JavaScript.

The foregoing description of various embodiments of the invention has been presented only for the purpose of illustration and description, and is not intended to be exhaustive or to limit the invention to the specific forms disclosed. Numerous modifications and adaptations thereof will be apparent to those skilled in the art without departing from the spirit and scope of the invention.

What is claimed is:

1. A method, comprising:
determining a context associated with an enterprise;
categorizing risks associated with the enterprise into a plurality of risk categories, each risk category including at least one risk;
determining a risk structure that correlates the risk categories; and
evaluating the risks associated with the enterprise.

2. The method of claim 1 wherein the risk categories include a plurality of financial, operational, strategic, and market risk categories.

3. The method of claim 2 further comprising at least one of regulatory, credit, liquidity, property, liability, intellectual property, and political risk categories.

4. The method of claim 1 wherein the risk structure includes a plurality of nodes configured in a tree-like hierarchical structure, each node corresponding to one of the risk categories.

5. The method of claim 4 wherein the tree-like hierarchical structure is configured to allow additional nodes to be added, each additional node corresponding to an additional risk category.

6. The method of claim 1 wherein the risk structure is dynamically reconfigurable.

7. The method of claim 1 further comprising using an interactive questionnaire to collect information related to the context associated with the enterprise.

8. The method of claim 1 further comprising applying statistical data to derive information related to the context associated with the enterprise.

9. The method of claim 1 wherein the evaluation includes constructing a probability distribution function for at least one of the risks.

10. The method of claim 9 further comprising constructing a set of scenarios associated with the at least one of the risks and assigning a probability value to each scenario.

11. The method of claim 1 wherein the evaluation includes defining at least one parameter associated with each risk.

12. The method of claim 1 wherein the evaluation includes assigning a score to at least one of the risks, the score being measured relative to a predetermined risk measurement unit.

13. The method of claim 12 further comprising determining an industry benchmark and using the industry benchmark as the risk measurement unit.

14. The method of claim 1 further comprising providing an integrated assessment of the risks associated with the enterprise, the integrated assessment based at least in part on the evaluation.

15. The method of claim 14 wherein the integrated assessment includes an assessment of a risk management strategy associated with the enterprise.

16. The method of claim 15 furthering comprising carrying out a “what-if” analysis so as to revise the risk management strategy.

17. A computer program product stored in a computer-readable medium and executable by a processor, the computer program product comprising instructions to:
determine a context associated with an enterprise;
categorize risks associated with the enterprise into a plurality of risk categories, each risk category including at least one risk;
determine a risk structure that correlates the risk categories; and
evaluate the risks associated with the enterprise.

18. The database of claim 17 wherein the computer program product is included in a database stored in the computer-readable medium.

19. The database of claim 17 wherein the computer-readable medium is included in a computer.

20. The database of claim 17 wherein the computer-readable medium resides on a network server.
